(19) United States
(12) Patent Application Publication
(10) Pub. No.: US 2002/0057849 A1
(43) Pub. Date: May 16, 2002

(54) Image transmission method and apparatus

(75) Inventor: Jiro Senda, Kanagawa (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: FUJI PHOTO FILM CO., LTD

(21) Appl. No.: 09/987,076

(22) Filed: Nov. 13, 2001

(30) Foreign Application Priority Data
Nov. 13, 2000 (JP) 2000-345251

(51) Int. Cl. G06K 9/36

(52) U.S. Cl. 382/284

(57) ABSTRACT

A system for efficiently transferring composite images via a network, the composite images having been formed from a plurality of partial images generated by a modality. The system is configured to transmit a composite image, original images from which the composite image is formed, or combining data required for generating a composite image based on the original images, or a combination thereof, according to an output destination device or device attribute specified by the user.

### BACKGROUND OF THE INVENTION

1. Field of the Invention

The present invention relates to an image transmission method and apparatus for transferring images generating by imaging equipment connected to a network, images processed by image processing equipment, or images archived in image storing devices. The present invention particularly relates to an image transmission method and apparatus for effectively transferring images in a composite image transmission process, wherein a single composite image is formed from a plurality of original partial images and transmitted to another device.

2. Description of the Related Art

Various diagnostic imaging devices have come into use in the medical profession in recent years. Some common examples of these include ultrasound diagnostic equipment, magnetic resonance (MR) scanners, computed tomography (CT) scanners, and computed radiography (CR) scanners. Such diagnostic imaging apparatus are referred to as modality equipment. Image data generated with these modalities is printed out on film printers, displayed on monitors, archived on storage media such as magnetic disks and magneto-optical disks, or processed in other ways.

When performing a CT scan, for example, the examiner operates the CT scanner to obtain tomographic images of the patient. These images can be displayed on a video display in the console of the device. By operating a film recorder called an imager, which is connected to the CT scanner, the examiner can specify images needed for the diagnosis. The specified images are output to the imager and printed out on large sheets of film using a film printer. This film is provided to the physician in charge as a diagnostic image for assisting in diagnosing the patient.

Hospitals equipped with multiple types of modalities employ a network to interconnect the various modalities with printers, displays, image archives for storing images, and the like. With this configuration, image data generated by the various modalities or stored in the image storing devices can be displayed on display devices or output to printers in various locations in the hospital as needed.

With this type of network system, the user specifies a destination device, such as a printer, display, or database, to transfer images generated by ultrasound diagnostic equipment, MR scanners, CT scanners, and CR scanners, and the like in order to display, output, or store the images.

However, images generated by modalities in this type of network environment are often only partial images. These partial images are combined to form a single composite image, which is transferred to the specified destination device, i.e. printer, display, database, or the like. Japanese unexamined patent publication application No. 2000-232976 discloses a configuration for generating composite image data by combining partial image data generated for the same subject.

When distributing these composite images, ordinarily a process is executed to transmit both the composite image and the plurality of original partial images making up the composite image to a destination device. This is necessary as the type of image required differs according to the intended use of the image in the destination device, and the original images are required when performing a recombining process and the like.

Since the volume of data in these medical images can be large, transferring a plurality of original images and the composite image can place a great burden on both the network and the receiving device, thereby decreasing the overall throughput of the network system.

### SUMMARY OF THE INVENTION

In view of the foregoing, it is an object of the present invention to provide an image transmission method and apparatus that eliminates unnecessary image transfers and improves the system throughput by a process of selecting images to be transmitted according to the destination of the transmission.

These objects and others will be attained by an image transmitting device comprising a combining process means for generating a composite image by joining a plurality of original images; a storing means for storing the composite image generated by the combining process means and the original images that the composite image comprises together with corresponding combining data required for generating the composite image; and a selection process means for executing a selection process that outputs one or more of the composite image, original images, or combining data as output data based on an output destination device specified as the destination for image transmission.

According to another aspect of the present invention, the image transmitting device further comprises an output data selection table that associates identification data for a plurality of destination devices with various output or non-output data of the composite image, original images, and combining data. The selection process means executes the selection process on output data based on settings in the output data selection table.

According to another aspect of the present invention, the selection process means executes a selection process on output data predetermined based on attributes of the output destination device.

According to another aspect of the present invention, the selection process means executes a selection process on output data based on user specifications.

According to another aspect of the present invention, an image transmitting method comprises a composite process step for generating a composite image by joining a plurality of original images; a storing step for storing the composite image generated by the combining process means and the original images that the composite image comprises together with corresponding composite data required for generating the composite image; and a selection process step for executing a selection process that outputs one or more of the composite image, original images, or combining data as output data based on an output destination device specified as the destination for image transmission.

According to another aspect of the present invention, the selection process in the selection process step is executed on output data based on settings in an output data selection table that associates identification data for a plurality of destination devices with various output or non-output data of the composite image, original images, and combining data.

According to another aspect of the present invention, the selection process in the selection process step is executed on output data predetermined based on attributes of the output destination device.

According to another aspect of the present invention, the selection process in the selection process step is executed on output data based on user specifications.

Additional objectives, features, and advantages of the present invention will be clarified in the detailed description of the embodiments provided below with the accompanying drawings.

### BRIEF DESCRIPTION OF THE DRAWINGS

In the drawings:

FIG. 1 is an example configuration of a communication network applying the system of the present invention for transmitting diagnostic or medical image data;

FIG. 2 is a block diagram showing the configuration of workstations, used to transmit images, connected to various modalities and destination devices;

FIG. 3 is a block diagram showing the construction of a workstation for verifying and transmitting images;

FIG. 4 is a block diagram illustrating an image combining process using the system of the present invention;

FIG. 5 is a flowchart showing the image combining process executed by the system of the present invention;

FIG. 6 shows an example configuration of an output data selection table used by the output selection process executed by the system of the present invention; and

FIG. 7 is a flowchart showing the output selection process executed by the system of the present invention.

### DESCRIPTION OF THE PREFERRED EMBODIMENTS

An image transmission method and apparatus according to preferred embodiments of the present invention will be described while referring to the accompanying drawings.

System Configuration

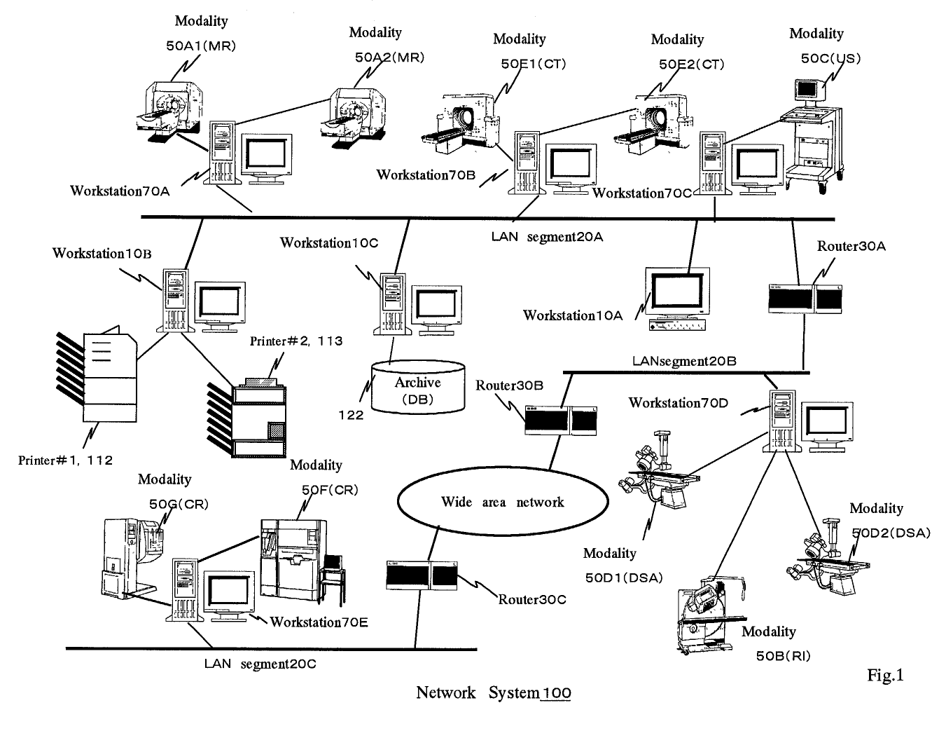

FIG. 1 is a conceptual diagram showing an example configuration for a network system 100 serving as the image transmission apparatus of the present invention. Various modalities 50 are connected on the network, including an ultrasound diagnostic device, MR scanner, CT scanner, and CR scanner. Medical and diagnostic images generated by these devices are transferred to workstations 10A, 10B, and 10C for verifying the images and the transfer destination and controlling the display, printing, and storage of images via the network. Workstations execute various processes to display images, output images for printing, and store images in a database.

As mentioned above, the workstations 10 control devices for electronically manipulating medical images such as printers, viewers, and archives connected to the network. In addition, workstations 70 are linked to each modality through the network for performing verification and transmission processes. Both the workstations 10 and 70 are normally connected to the network using network interface cards (NIC).

An example of this network construction shown in FIG. 1 is a single local area network (LAN) installed in a hospital. The LAN can be configured of a single LAN segment 20 or a plurality of LAN segments (segments 20A, 20B, and 20C in this example) interconnected via a router (or gateway) 30. The network may also be configured of a wide area network (WAN) connecting LANs of remote hospitals via dedicated lines or a WAN similar to the Internet.

Each workstation 10 and 70 is connected transparently on the network according to a prescribed communication protocol. For example, with the Open System Interconnection (OSI), which is a model for communication standards, the physical and data link layers of the network employ the Ethernet protocol, while the network and transport layers employ Transmission Control Protocol/Internet Protocol (TCP/IP). The session layer and higher layers employ vendor-specific protocols used by the manufacturers of the medical equipment.

One common protocol in the field of medicine used for upper layers is Digital Imaging and Communication in Medicine (DICOM). DICOM is a communication protocol used for medical images that was established by the American College of Radiology (ACR) and the National Electrical Manufacturers Association (NEMA). However, some modalities connected to networks use their own vendor-specific protocols different from DICOM.

A plurality of modalities for generating and supplying medical and diagnostic images are connected on the network shown in FIG. 1. These modalities include magnetic resonance (MR) scanners 50A (50A1 and 50A2) for use in computer tomography, an RI device 50B, an ultrasound device 50C, digital subtraction angiography (DSA) devices 50D (50D1 and 50D2), computer tomography (CT) scanners 50E (50E1 and 50E2), computer radiography (CR) devices 50F and 50G, and the like. Images obtained by these modalities are output from the workstations 70A and 70B to prescribed destination devices via the network.

The workstations 70A and 70B and the like are connected to one or more modalities commonly provided in specialized examination rooms of hospitals (not shown). The workstations 70A and 70B include a monitor for viewing images obtained by the modalities and storage media, such as magnetic disks, DVD discs, or the like for temporarily storing images. Modalities take images of various regions on the patient and from various angles. A combining process applying a method of identifying image positions, such as template matching, is performed with the workstations 70A and 70B to generate a composite image from these various partial images. The generated composite image or the original images used to form the composite image are output from the network to a destination device employing the workstations 70A and 70B as transmission devices. Users employ the workstations 70A and 70B as verifying and distributing devices to specify the transfer destination of the images and to execute the transfer. A transfer destination is, for example, an image viewer used to display images, a printer for printing out the images, or an archive for storing the images. When transferring image data, attribute data is added to the image data (original images and composite image) and transferred with the images. The attribute data is supplementary data related to the image data, such as the patient name, patient ID, examination date, examination conditions, patient birth date, supervising physician, and the like.

The workstation 10A functions as an image viewer and extracts archived diagnostic images from a database in the file server, for example, allowing users to confirm data on the display. The workstation 10B functions as a print server, outputting data to be printed on one or more printers connected locally. In the present embodiment, the local printers include a first printer 112 and a second printer 113.

The workstation 10C functions as a file server and stores image data in an image archive 122 in the form of a database connected to the file server. The image data is stored along with related attributes, including patient name, patient, ID, examination date, examination conditions, patient birth date, supervising physician, and the like. The image archive 122 is a high-capacity storage device capable of storing an enormous number of diagnostic image files. In most cases, the image data is compressed before storage.

The user can set the image viewer, printers, and archive as output destinations for medical images taken by the ultrasound diagnostic equipment, MR scanners, CT scanners, and CR scanners, and other modalities 50A-50G. In other words, these devices can be set as an output or storage destination for transferring data over the network. Using the workstations 70A and 70B, the user specifies the image viewer, printers, database, or the like as a destination for the images. Based on the device specified as the destination, the user selects composite images, original images, or combining data including parameters required to generate a composite image from the originals. The processes for generating composite images and selecting images for transmission are described below.

Configuration of a Verification and Transmission Device

As briefly described above with reference to FIG. 1, diagnostic and other medical images generated by modality devices are transferred from the workstations 70 to a printer for generating printed output, an image viewer for displaying the images, or an archive for storing the data. Here, the workstations 70 connected to the modality devices serve to verify and transmit the images, and enable the images to be either outputted or stored.

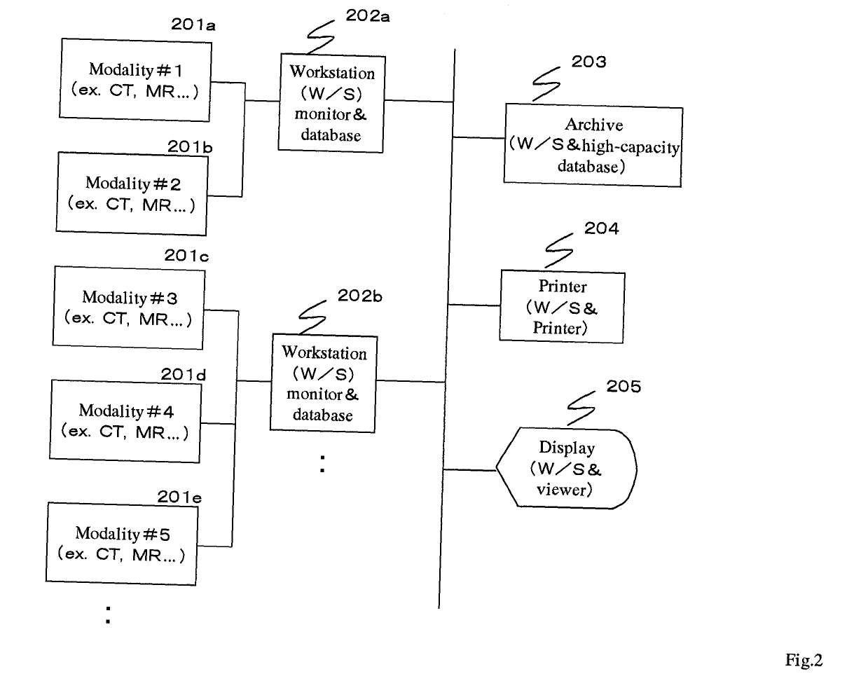

FIG. 2 is a block diagram showing the overall connection configuration of various modalities, workstations, displays, printers, and archives.

A workstation 202a for verifying and transmitting data is connected to two modalities 201a and 201b. The workstation 202a receives diagnostic images generated by the modalities 201a and 201b and specifies an archive 203, a printer 204, or a display device 205 as the destination device for transmitting the images. The diagnostic images are transmitted via the network to the specified destination device to be stored or processed.

A workstation 202b, also serving to verify and transmit data, is connected to three modalities 201c, 201d, and 201e. The workstation 202b receives diagnostic images taken by these modalities 201c, 201d, and 201e and specifies the archive 203, printer 204, or display device 205 as the destination of the images. The diagnostic images are transmitted via the network to the destination device to be stored or processed.

The workstations 202a and 202b have a monitor for displaying diagnostic images taken by the modalities and a hard disk or other data storage medium for temporarily storing these diagnostic images. The workstations 202a and 202b execute processes for combining a plurality of images taken by the modalities to generate a composite image. In order to combine a plurality of images, a template matching process, for example, is applied to identify shared portions of each original image.

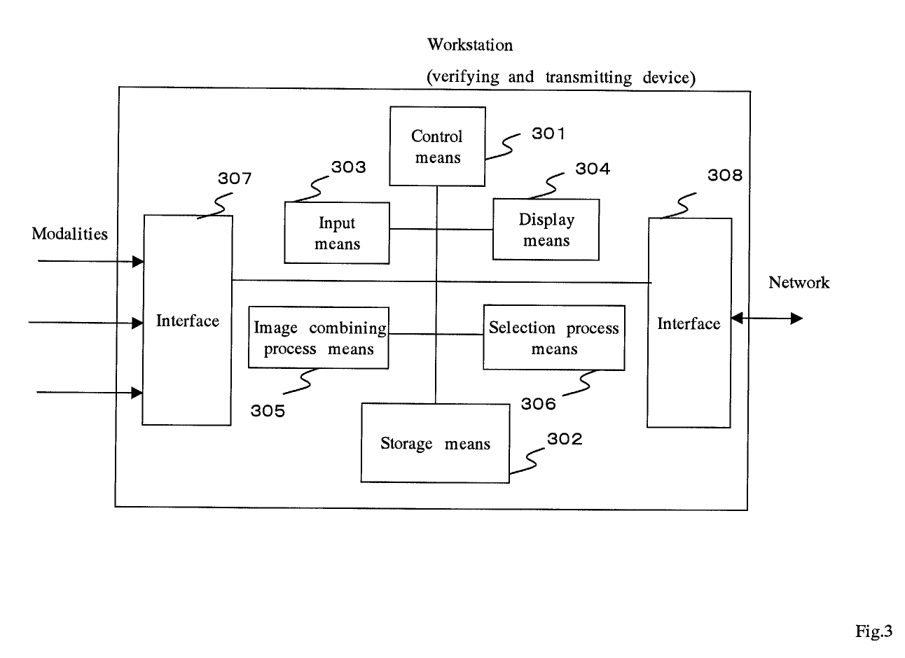

FIG. 3 shows the configuration of the workstations 202a and 202b used to conduct processes for generating composite images and selecting images for transfer. The workstations 202a and 202b comprise an interface 307 that receives images generated by modalities; an interface 308 that transmits images via the network to the printer, image viewer, archive, or the like indicated as the destination device; a storage means 302 for storing original images generated by the modalities and composite images generated by combining the original images; a display means 304 for displaying images taken by the modalities or composite images; an input means 303 for executing commands or data input, such as specifying the form of image processing and editing data; an image combining process means 305 for executing the image combining process; and a selection process means 306 for executing a process to select images for the destination device.

Image Combining Process

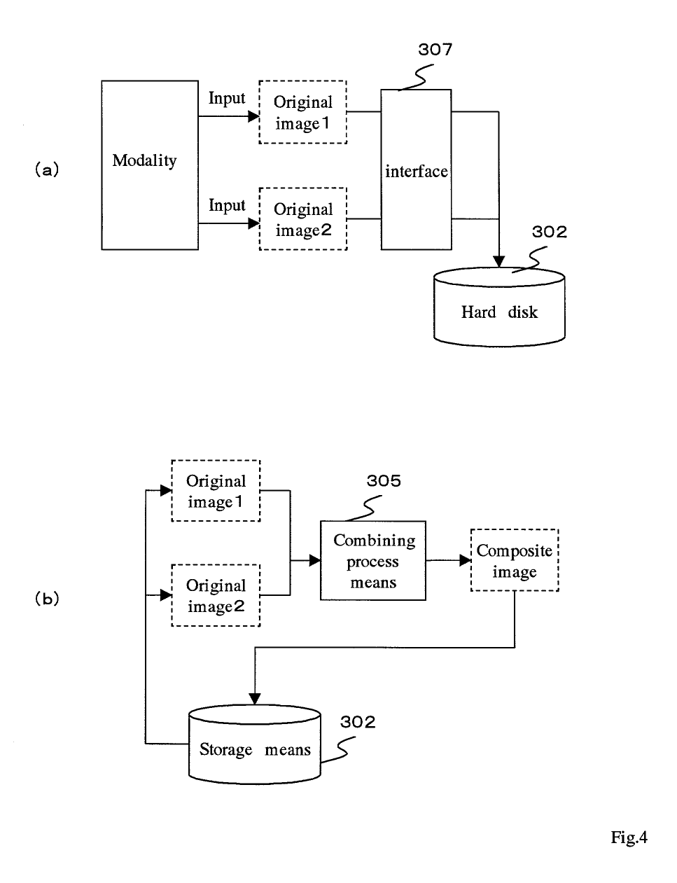

FIG. 4 is an explanatory diagram showing the processes executed in the workstations for generating and storing composite images. FIG. 4(a) shows the process of inputting a plurality of partial images from modalities. A first original image and second original image are inputted as partial images via the interface 307 of the workstation and stored on a hard disk serving as the storage means 302. Although this example uses only two partial images, three or more partial images can be input in the same manner. When storing images on the hard disk 302, attribute data related to the images, such as patient name, patient ID, examination date, examination conditions, patient birth date, supervising physician, and the like is stored together with the image data.

FIG. 4(b) shows the process for extracting the partial images from the hard disk 302 and generating a composite image. When generating a composite image, the plurality of related original images are extracted based on attribute data included with the images. The image combining process is executed in the image combining process means 305.

The image combining process means 305 generates a composite image from the plurality of original images. This image combining process can be executed by various methods, for example, such as template matching method. When executing the image combining process, the position adjustment process is preferably executed for adjusting the position of the plural original images. If the position error is little, or precise position accuracy is not required, the position adjustment process can be omitted. When generating composite images, data identifying the original images is added to the composite image as supplemental data. The identification data is in the form of an image ID identifying the original image. By setting identification data for the original images as supplemental data added to the composite image, the user working with the data can immediately extract the image idea for the original images based on the composite image. Based on these image IDs, the user can then extract the original images from a storage means on the user's own workstation or a remote storage means accessed via a network.

Normally composite images are formed under fixed conditions. For example, the images are set with conditions regarding the relative positioning of images or parameters, such as the resolution of each original image. Image parameters are generally set to be compatible with the devices used to display or print the images. Composite images generated based on positioning conditions and parameters set in one device are sometimes not desirable for another device. To generate a suitable composite image in the second device, it is necessary in this case to repeat the process for combining the original images, while setting suitable parameters. Resolution and other device-dependent parameters must be set for the particular device in order to form a desirable composite image. In this recombining process, the identifiers of the original images are an effective searching means for efficiently extracting the original images.

When combining conditions specific to the printer, image viewer, or other output device have been set, a combining process applying these combining conditions is automatically executed after the original images have been extracted using the image identifiers.

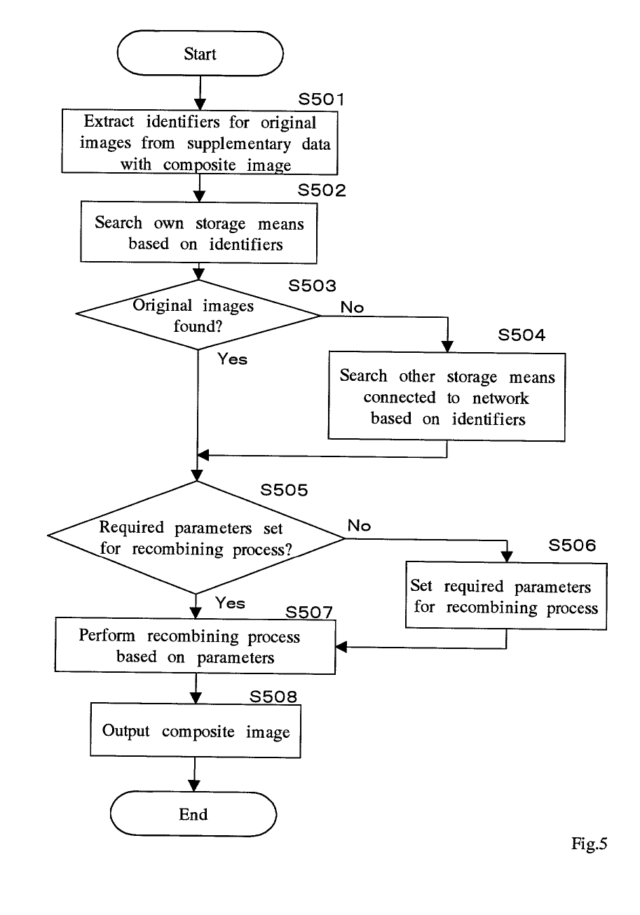

The flowchart in FIG. 5 shows the steps of a recombining process for generating a new composite image appropriate for the targeted device. The process extracts the original images based on identifiers included with the composite image and sets combining conditions for the acquired original images. The process in FIG. 5 is executed by the workstation shown in FIG. 3, for example.

In Step S501, identifiers for the original images (e.g. image IDs) are extracted from the supplementary data included with the composite image. In Step S502, a storage means in the current device is searched based on these identifiers. If the original images having the relevant identifiers are not found in the storage means (No in S503), a search using the identifiers is conducted in S504 in archives or other large-capacity storage devices connected to a network.

The recombining process is executed after extracting the original images from a storage device on the current device or another device. In Step 505, the process determines whether parameters required for recombination, such as resolution and the like, have been set in the combining means of the device. These parameters include positioning parameters for linking the images or resolution, picture quality settings, and the like. If the resolution has been set (Yes in S505), a composite image is automatically generated in S507 from the original images based on the parameters. If the parameters have not been set (No in S505), the parameters are set manually in S506. The combining process is executed after parameters have been set. The composite image is output to a monitor, printer, or the like connected to the current device.

The process can be set such that the user need only input a command for executing the recombining process after obtaining an original composite image in S501 in order to execute all subsequent processes automatically, including extracting identifiers for original images, obtaining original images, determining whether parameters have been set, performing the recombining process, and outputting the composite image. Only when parameters required for recombination are not set does the process shift into manual mode to execute the parameter setting process in Step S506.

By assigning identifiers for the original images and saving the identifiers as supplementary data with the composite image, the original images can be readily extracted from storage based on the composite image, enabling effective execution of a recombining process.

Image Transmission Process

Next an image transmission process executed in the device generating the composite image will be described. In this process, the composite image, original images, as well as combining data, such as positioning data required for the combining process are selectively output according to the destination device.

As described above, a large volume of data is generally required for images, particularly diagnostic or medical images generated by modalities. Therefore, the process for transmitting composite images generated from a plurality of original images together with the original images to a destination device, such as an archive, printer, or image viewer, increases the load on the network and destination device. The image transmission process in the system of the present invention selects images based on the destination device and transmits the selected images or data to that device via a network.

An example of this process will be described using the workstation shown in FIG. 3 as the image transmission device. The selection process means 306 of the workstation selects images to be output by referring to an output data selection table stored in the storage means 302 based on the destination device specified by the user. The output data selection table associates output image data with the destination devices.

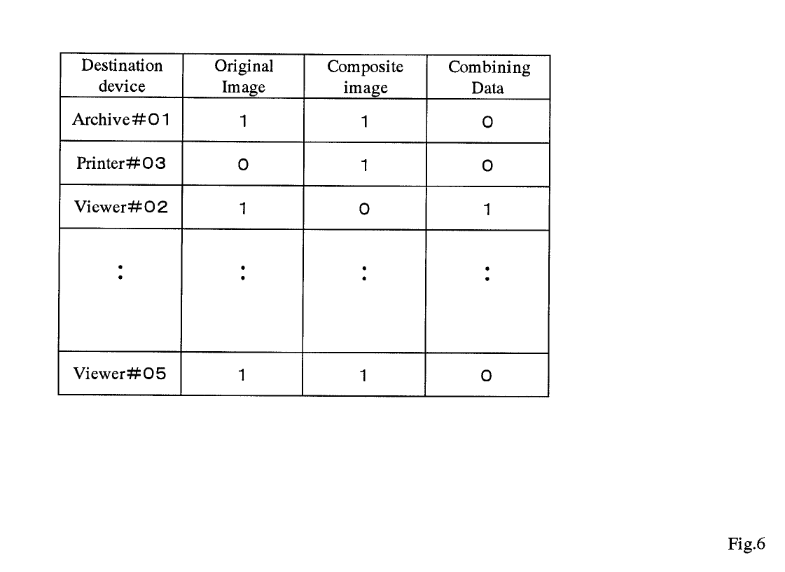

FIG. 6 shows a sample configuration of the output data selection table. The table includes a list of destination devices, such as an archive #01, printer #03, and viewer #02. Numbers next to the destination devices indicate what time of data should be output with “1” indicating data to be output, and “0” indicating data not to be output.

For example, data including the original images, and composite image is output to the archive #01; only composite images are output to the printer #03; both original images and combining data are output to the viewer #02; and original images and composite images are output to the viewer #05. Here, the combining data includes parameters required for the combining process. The selection process means 306 first determines the corresponding destination device in the output data selection based on data specified by the user for the destination device. Next, the selection process means 306 verifies the image output data associated with that destination device.

The selection process means 306 transmits only data in the output data selection table assigned the value “1” as output data to the destination device specified by the user. This automatic selection process prevents unnecessary data from being transmitted to the destination device, thereby reducing the processing load on the network and destination device.

The output data selection table in FIG. 6 sets output data for each individual device. However, the output data selection table can also specify output data based on attributes of the destination device, for example, whether the destination is a printer, viewing device, storage device, or the like. In this case, output data is selected based on an attribute of the destination device, which is determined from destination device data specified by the user. This process can also be configured to enable the user to select desired output data by displaying a window for selecting output data in the display means 304.

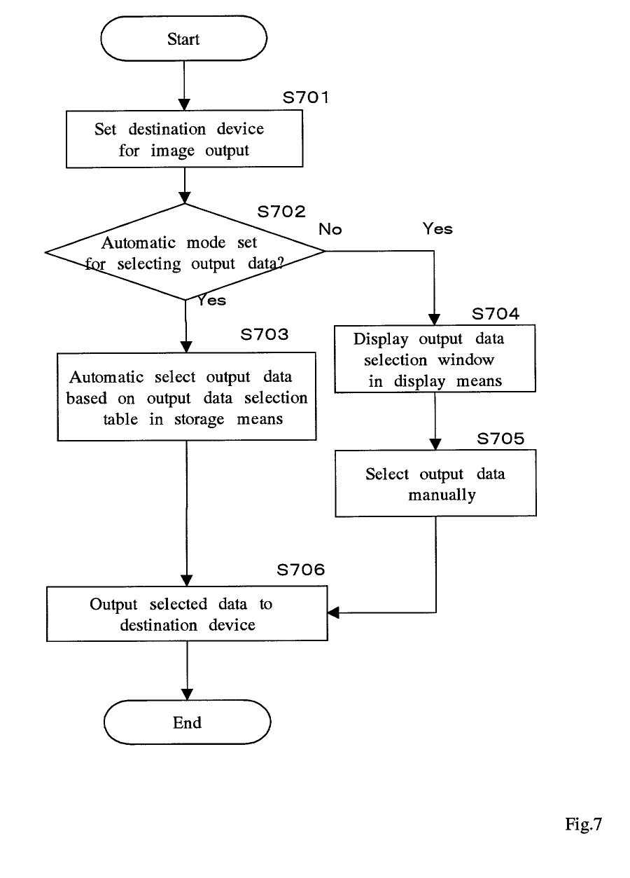

The flowchart in FIG. 7 shows the output selection process for outputting composite images and the like. In Step S701, the user specifies the output destination. Here, the output destination is an archive, printer, viewing device, or the like.

In Step S702, the process determines whether the process for selecting output data is set to be automatic. The workstation of FIG. 3 is configured to selectively execute a process for automatically selecting output data or a process for allowing the user to set output data manually. When the automatic image selection process has been set, output data is automatically selected in Step S703 based on the user-specified destination device. Here, the output data selection table in FIG. 6 described above is extracted from the storage means 302 and referenced. In Step S706, the selected data is output to the destination device.

When the image selection process is set to manual mode, an output data selection window is displayed in the display means 304 in Step S704. The user manually selects output data in Step S705, and the selected data is output to the destination device in Step S706.

By selectively outputting image data based on the destination device, image data not necessary for the destination device is not transmitted via the network, thereby reducing traffic on the network. Accordingly, it is possible to prevent a decline in system throughput by reducing the load on the network and destination devices. Besides the above mentioned image selection process, any other image selection process can be adapted as far as the selected data can be output to the destination device.

The image transmission device in the example described above is a verifying and transmitting device such as a workstation connected to each modality. However, the same processes can be executed when transmitting images from workstations set as servers for other image viewers, printers, and storage devices to another device connected to the network.

While the invention has been described in detail with reference to specific embodiments thereof, it would be apparent to those skilled in the art that many modifications and variations may be made therein without departing from the spirit of the invention, the scope of which is defined by the attached claims.

As described above, the method and apparatus for transmitting images according to the present invention are configured to selectively output composite images generated by a process for combining images generated by a modality, original images as partial images of the composite image, and combining data required for generating composite images based on the original images according to the destination device to which the image data is output. Accordingly, the present invention decreases traffic on the network, reduces the load on the network and destination devices, and improves system throughput.

What is claimed is:

1. An image transmitting device comprising:
combining process means for generating a composite image by joining a plurality of original images;
storing means for storing the composite image generated by the combining process means and the original images that the composite image comprises together with corresponding combining data required for generating the composite image; and
selection process means for executing a selection process that outputs one or more of the composite image, original images, or combining data as output data based on an output destination device specified as the destination for image transmission.

2. An image transmitting device as recited in claim 1, further comprising an output data selection table that associates identification data for a plurality of destination devices with various output or non-output data of the composite image, original images, and combining data; and the selection process means executes the selection process on output data based on settings in the output data selection table.

3. The image transmitting device as recited in claim 1, wherein the selection process means executes a selection process on output data predetermined based on attributes of the output destination device.

4. An image transmitting device as recited in claim 1, wherein the selection process means executes a selection process on output data based on user specifications.

5. An image transmitting method comprising:
a composite process step for generating a composite image by joining a plurality of original images;
a storing step for storing the composite image generated by the combining process means and the original images that the composite image comprises together with corresponding composite data required for generating the composite image; and
a selection process step for executing a selection process that outputs one or more of the composite image, original images, or combining data as output data based on an output destination device specified as the destination for image transmission.

6. An image transmitting method as recited in claim 5, wherein the selection process in the selection process step is executed on output data based on settings in an output data selection table that associates identification data for a plurality of destination devices with various output or non-output data of the composite image, original images, and combining data.

7. An image transmitting method as recited in claim 5, wherein the selection process in the selection process step is executed on output data predetermined based on attributes of the output destination device.

8. An image transmitting method as recited in claim 5, wherein the selection process in the selection process step is executed on output data based on user specifications.
